(19) United States
(12) Patent Application Publication
(10) Pub. No.: US 2003/0045326 A1
(43) Pub. Date: Mar. 6, 2003

(54) Computer port powered wireless sound transmission and a method therfor

(76) Inventor: James L. Bailey, Shreveport, LA (US)

Correspondence Address: WEISS & MOY PC, 4204 NORTH BROWN AVENUE, SCOTTSDALE, AZ, 85251, US

(21) Appl. No.: 09/945,580

(22) Filed: Sep. 4, 2001

(51) Int. Cl. H04M 1/00

(52) U.S. Cl. 455/557; 455/66

(57) ABSTRACT

A computer port is used to power a wireless transmission of audio signals from a sound card of a personal computer to a home entertainment system for high fidelity sound production. The computer port comprises any computer port that provides power. The computer port is used to power a FM transmitter that is connected to an audio output of a sound card of a personal computer.

### RELATED APPLICATIONS

This Application is related to U.S. Pat. No. 5,946,604, issued Aug. 31, 1999 in the name of James Lee Bailey, and assigned to the 1-O-X Corporation. The present patent application is in the name of the same inventor and is assigned to the same assignee. The above U.S. patent is hereby incorporated by reference into the present patent application.

### BACKGROUND OF THE INVENTION

1. Field of the Invention

This invention relates generally to high fidelity sound reproduction and, more specifically, to a wireless transmission of audio signals from a sound card of a personal computer to a home entertainment system receiver for producing high fidelity sound using the power provided by a computer port and a method therefore.

2. Description of the Prior Art

Personal computers for home use are becoming more and more a key element of a home entertainment center. The personal computer may include a sound card that processes and stores a digital signal representation of sound, such as music. Usually, the sound card is connected to a pair of speakers in the computer, where the sound is reproduced. However, the computer speaker are typically small and of poor construction. Thus, the quality of sound reproduction is relatively poor. The sound reproduction may be improved by connecting the output jack of the sound card via wires to an amplifier that drives loudspeakers of improved quality. However, the wires are often cumbersome and inconvenient. One solution to this problem is disclosed in U.S. Pat. No. 5,946,604 issued to Bailey, the inventor of the present invention. The '604 patent discloses a wireless link between a transmitter coupled to an audio output of a sound card of a personal computer and a high fidelity home entertainment receiver where power for the transmitter is provided from a MIDI port of the sound card.

In general, a MIDI port of a sound card of a personal computer is a dual-purpose port that can also be used to connect computer peripherals like a joystick, game pad, and the like. As a result, disconnecting the joystick or game pad and connecting a transmitter and visa versa may be necessary if both applications are used at the same personal computer. This may be inconvenient and troublesome. Furthermore, even though most sound cards utilize game ports, in some cases an adapter cable is required to connect external MIDI devices.

Therefore a need existed to provide a solution to the above mention problem. A need existed to provide the power for the transmitter used in the wireless link between the audio output of the sound card of the personal computer and the home entertainment receiver from a different source than the MIDI port of the sound card. A further need existed to provide the power for the transmitter without using additional cables and/or equipment. A still further need existed to provide the power for the transmitter in a way that is convenient and inexpensive.

### SUMMARY OF THE INVENTION

An object of the present invention is to provide a power source for a transmitter used in a wireless link between an audio output of a sound card of a personal computer and a home entertainment receiver other than a MIDI port of the sound card.

It is a further object of the present invention to provide a power source for the transmitter that does not uses additional cables and/or equipment.

It is a s till further object of the p resent invention to provide a power source for the transmitter that is convenient and inexpensive.

### BRIEF DESCRIPTION OF THE PREFERRED EMBODIMENTS

In accordance with one embodiment of the present invention, an apparatus for computer port powered wireless sound transmission is disclosed. The apparatus has a personal computer that includes a computer port and a sound card installed therein. An FM transmitter is connected to the computer port and coupled to the sound card for radiating a carrier signal that is modulated by an audio signal provided by the sound card. The carrier signal is being received by an FM receiver for high fidelity reproduction of the audio signal from the personal computer, wherein the computer port provides power to the FM transmitter.

In accordance with another embodiment of the present invention, a method for providing a wireless link between a sound card of a personal computer and a high fidelity FM receiver is disclosed. The method comprises the steps of: modulating a carrier signal provided by a transmitter with an audio signal provided by the sound card; radiating the modulated carrier signal; receiving the modulated carrier signal and reproducing the personal computer's sound with the high fidelity FM receiver; and providing power to the FM transmitter from a computer port.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a block diagram of the computer port powered wireless sound transmission according to the present invention.

### DETAILED DESCRIPTION OF THE PREFERRED EMBODIMENTS

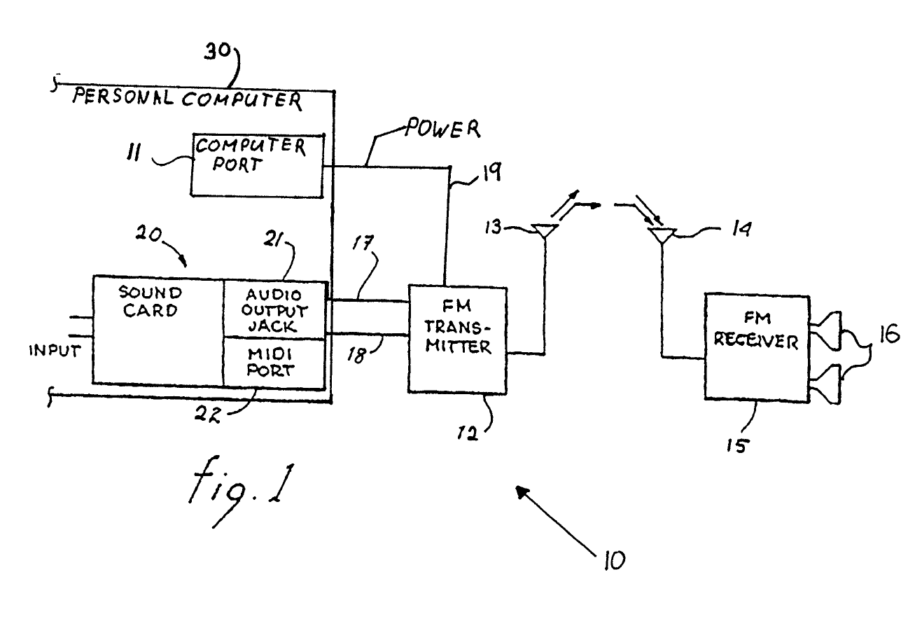

Referring to FIG. 1, a block diagram of the computer port powered wireless sound transmission 10 according to the present invention is shown. The computer port powered wireless sound transmission 10 generally comprises, in combination: a personal computer 30 including a sound card 20 and a computer port 11; a FM transmitter 12; antennas 13 and 14; a high fidelity FM receiver 15; and a pair of speakers 16. The sound card 20 comprises an audio output jack 21 and a MIDI/game port 22.

The audio output jack 21 of the sound card 20 is connected through signal lines 17 and 18 to the FM transmitter 12. By doing so, the left and right speaker output signals are provided to the transmitter 12. The computer port 11 is connected through a power line 19 with transmitter 12 to provide power to the transmitter 12. Within the FM transmitter 12, the speaker output signals modulate a carrier signal. The modulated carrier signal is radiated from the antenna 13 of the transmitter 12. Preferably, the radiation is at a frequency, unused by commercial broadcasters, in a range of 88 megahertz to 108 megahertz.

The radiation from the antenna 13 is received by the FM receiver 15 via the antenna 14. The receiver 15 replicates the speaker output signals and amplifies the signals thereafter. The replicated and amplified left and right hand speaker signals are provided to the speakers 16, whereby the sound is stereophonically reproduced.

In order to function as a power source for the transmitter 12, the computer port 11 can be any computer port of a personal computer that provides power. In one embodiment of the present invention, the computer port 11 is a USB port. In another embodiment of the present invention, the computer port 11 is a keyboard port, also known as PS/2 port. In still another embodiment of the present invention, the computer port 11 is a FireWire port, also known as IEEE 1394 port or i.LINK. It should be noted that these are only examples and should not be seen as to limit the scope of the present invention. As stated above, any computer port 11 which provides power will work. The computer port 11 should provide approximately five volts DC with a power capability of four watts to the transmitter 12.

By providing power to the transmitter 12 using a computer port 11 as a power source, problems associated with the use of a MIDI port 22 of a sound card 20 to power the transmitter 12 as illustrated in prior art are solved. Most personal computers on the market today are equipped with several PS/2 ports and a USB port. By using these standard computer ports as a power source for the transmitter used for the wireless link between an audio output of a sound card of a personal computer and a sound reproduction apparatus interference with other usages can be avoided. Using computer ports that provide power is also relatively inexpensive and convenient.

While the invention has been particularly shown and described with reference to preferred embodiments thereof, it will be understood by those skilled in the art that the foregoing and other changes in form and details may be made therein without departing from the spirit and scope of the invention.

What is claimed is:

1. An apparatus for computer port powered wireless sound transmission comprising, in combination:
a personal computer that includes a computer port and a sound card having at least one audio output installed therein; and
a FM transmitter connected to said computer port and coupled to said at least one audio output of said sound card for radiating a carrier signal that is modulated by an audio signal provided by said sound card, said carrier signal being received by a FM receiver for high fidelity reproduction of said audio signal from said personal computer, said computer port providing power to said FM transmitter.

2. The device of claim 1 wherein said computer port is a keyboard port.

3. The device of claim 2 wherein said keyboard port is a PS/2 port.

4. The device of claim 1 wherein said computer port is a USB port.

5. The device of claim 1 wherein said computer port is a IEEE 1394 port.

6. The apparatus of claim 1 wherein said computer port provides approximately 5 volts DC with a power capability of four watts to said FM transmitter.

7. A method for providing a wireless link between a sound card of a personal computer and a high fidelity FM receiver comprising the steps of:
modulating a carrier signal provided by a transmitter with an audio signal provided by said sound card;
radiating said modulated carrier signal;
receiving said modulated carrier signal and reproducing said personal computer's sound with said high fidelity FM receiver; and
providing power to said FM transmitter from a computer port.

8. The method of claim 6 wherein said radiating is at a frequency in a range of 88 megahertz to 108 megahertz.
